(19) United States
(12) Patent Application Publication
(10) Pub. No.: US 2003/0055642 A1
(43) Pub. Date: Mar. 20, 2003

(54) Voice recognition apparatus and method

(75) Inventor: Shouji Harada, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/237,092

(22) Filed: Sep. 9, 2002

(30) Foreign Application Priority Data
Sep. 14, 2001 (JP) 2001-279089
Feb. 12, 2002 (JP) 2002-034351

(51) Int. Cl. G10L 17/00

(52) U.S. Cl. 704/246

(57) ABSTRACT

Text data describing the contents of an uttered voice and voice data uttered by a user corresponding to the text data are stored as a pair of data. Text data and voice data are input, and recognition results peculiar to a user are learned before start-up based on a pair of the text data and the voice data, whereby a user-specific acoustic model or a user-specific filter is generated.

### BACKGROUND OF THE INVENTION

1. Field of the Invention

The present invention relates to a voice recognition apparatus for recognizing the contents of an uttered voice of a user, based on previously input voice information of the user. In particular, the present invention relates to a voice recognition apparatus having an enrollment function.

2. Description of the Related Art

Due to the recent rapid development of a computer technique, a voice recognition apparatus is being put into practical use, which is capable of recognizing the contents of an uttered voice of a user that is analog data and controlling various digital applications.

In order to enhance the precision of such voice recognition, it is required to previously collect user's voice data, store it, and previously learn recognition results peculiar to the user. For example, in the case of generating a user-specific acoustic model, it is required to conduct an operation called an enrollment in which an acoustic model reflecting the recognition results peculiar to the user is previously generated. More specifically, in an acoustic model based on voice data regarding an indefinite number of users, it is difficult to exactly recognize voice data peculiar to a user, and there is a high possibility of misrecognition due to a habit and an intonation of utterance of a user. Therefore, it is highly required that a userspecific acoustic model is generated.

A specific operation is as follows. The contents of an uttered voice previously prepared by a voice recognition apparatus are presented to a user, and a user-specific acoustic model is generated using voice data uttered by the user in accordance with the presented contents.

FIG. 1 shows an exemplary configuration of a conventional voice recognition apparatus as described above. In FIG. 1, reference numeral 1 denotes an utterance target text data presenting part, 2 denotes a voice input part, 3 denotes a voice recognizing part, 4 denotes an acoustic model storing part, and 5 denotes a user-based acoustic model storing part.

First, in the utterance target text data presenting part 1, the contents to be uttered when voice data is input are displayed to a user as text data. The text data may be displayed on a screen or may be output from a printer or the like.

Then, in the voice input part 2, voice data uttered by the user in accordance with the displayed text data is input. The voice recognizing part 3 recognizes the voice data by labeling the input voice data in accordance with an acoustic model generated based on voice data regarding an infinite number of users previously prepared in the acoustic model storing part 4.

As an acoustic model to be generated here, a general HMM (Hidden Markov Model) is considered. Labeling is conducted by obtaining an optimum phoneme group using a Viterbi algorithm with respect to the HMM. Needless to say, the configuration of an acoustic model is not particularly limited to a HMM. There is no particular limit to a labeling method.

Furthermore, in the voice recognition in the voice recognizing part 3, there is a phoneme line that is not recognized exactly. Therefore, labeling is corrected, a user-specific acoustic model is generated based on the input voice data, and stored in the user-based acoustic model storing part 5.

In the above description, although a method for previously learning an acoustic model has been exemplified, there is no particular limit to an object to be previously learned.

However, according to the above-mentioned conventional method, in order to recognize a voice while keeping a high recognition precision, every time a voice recognition system is newly used or installed, it is required to ask a user to input voice data so as to previously learn the recognition results peculiar to the user. More specifically, even in the case of using a voice recognition apparatus of the same type, if a plurality of them are used, it is necessary to conduct an enrollment operation and the like for each voice recognition apparatus, which requires a user to input a voice with the same contents each time. Consequently, a user has to conduct an excess repeated operation.

Furthermore, regarding the contents for utterance, it is required that a user should utter a voice in accordance with the previously determined contents, and it becomes a large burden for the user to utter a predetermined amount unfamiliar sentence.

### SUMMARY OF THE INVENTION

Therefore, with the foregoing in mind, it is an object of the present invention to provide a voice recognition apparatus and method capable of reflecting the recognition results peculiar to a user without newly learning them, as long as learning regarding the recognition results peculiar to the user is conducted at least once before start-up.

In order to achieve the above-mentioned object, a voice recognition apparatus of the present invention includes: a voice information storing part for storing, as a pair of data, text data describing contents of an uttered voice and voice data uttered by a user corresponding to the text data; and a voice information input part for inputting the text data and the voice data, wherein recognition results peculiar to the user are learned before start-up based on the text data and the voice data that are a pair of data.

Because of the above configuration, even in the case where a plurality of voice recognition apparatuses are used, it is not required for a user to reinput a voice for respective voice recognition apparatuses, and it becomes possible to obtain a voice recognition apparatus in which a recognition precision at a predetermined level is maintained without allowing a user to conduct a repeated voice input operation.

Furthermore, it is preferable that the voice information storing part is a data server accessible via a network. This is because the voice information storing part can also be used in another voice recognition apparatus connected to a network.

Furthermore, it is preferable that the text data is created based on a document owned by the user. This is because it is considered that a burden for inputting a voice may be small with text data which a user is familiar with.

Furthermore, it is preferable that the recognition results or results obtained by correcting the recognition results are used as the text data. This saves labor for preparing text data, and a corrected portion can be learned as a portion that is likely to be misrecognized.

Furthermore, it is preferable that the text data describing contents of an uttered voice and the voice data uttered by a user corresponding to the text data are stored as a pair of data in a physically movable storage medium. This is because the text data and the voice data can be used in another voice recognition apparatus.

Furthermore, it is preferable that a pair of the text data and the voice data stored in the physically movable storage medium are input from the voice information input part. This is because a repeated input by a user can be avoided.

Furthermore, the present invention is characterized by a method for recognizing a voice and a recording medium storing a program to be executed by a computer for realizing the method, the method or the program including: storing, as a pair of data, text data describing contents of an uttered voice and voice data uttered by a user corresponding to the text data; and inputting the text data and the voice data, wherein recognition results peculiar to the user are learned before start-up based on the text data and the voice data that are a pair of data.

Because of the above configuration, by loading the program onto a computer for execution, even in the case where a plurality of voice recognition apparatuses are used, it is not required for a user to reinput a voice for respective voice recognition apparatuses, and it becomes possible to obtain a voice recognition apparatus in which a recognition precision at a predetermined level is maintained without allowing a user to conduct a repeated voice input operation.

Because of the same configuration as described above, the present invention is also applicable to a voice authentication apparatus, and the similar effects can be expected.

These and other advantages of the present invention will become apparent to those skilled in the art upon reading and understanding the following detailed description with reference to the accompanying figures.

### BRIEF DESCRIPTION OF THE DRAWINGS

FIG. 1 is a view showing a configuration of a conventional voice recognition apparatus.

FIG. 2 is a view showing a configuration of a voice recognition apparatus of Embodiment 1 according to the present invention.

FIG. 3 is a view showing a configuration of a voice recognizing part in the voice recognition apparatus of Embodiment 1 according to the present invention.

FIG. 4 is a view illustrating the determination whether or not voice data can be used.

FIG. 5 is a view showing a configuration of a voice recognizing part in the voice recognition apparatus of Embodiment 1 according to the present invention.

FIG. 6 is a flow chart illustrating the processing in the voice recognition apparatus of Embodiment 1 according to the present invention.

FIG. 7 is a view showing a configuration of a voice recognition apparatus of Embodiment 2 according to the present invention.

FIG. 8 is a flow chart illustrating the processing in the voice recognition apparatus of Embodiment 2 according to the present invention.

FIG. 9 is a view illustrating a computer environment.

### DESCRIPTION OF THE PREFERRED EMBODIMENTS

Embodiment 1

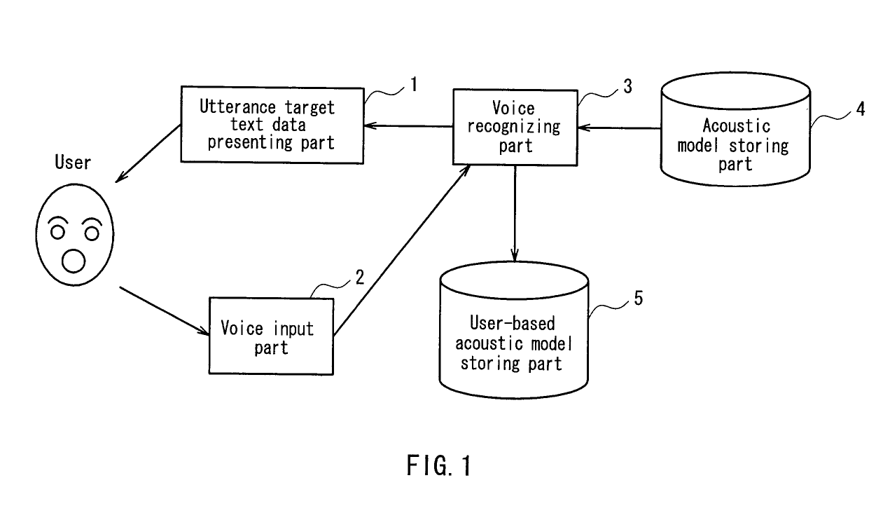

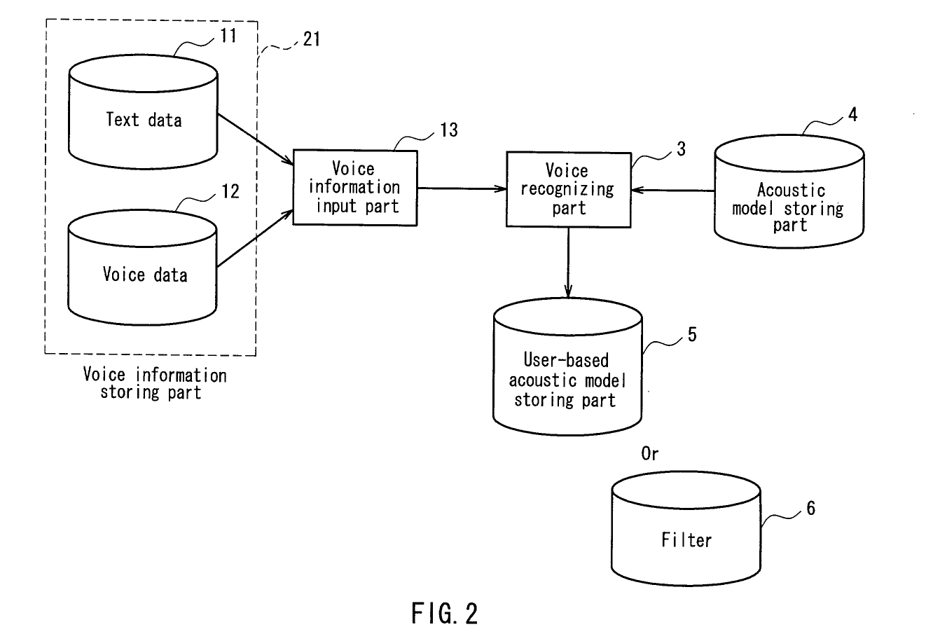

Hereinafter, a voice recognition apparatus of Embodiment 1 according to the present invention will be described with reference to the drawings. FIG. 2 is a view showing a configuration of the voice recognition apparatus of Embodiment 1 according to the present invention. In FIG. 2, parts having the same functions as those in FIG. 1 are denoted with the same reference numerals as those therein, and detailed descriptions thereof will be omitted here.

The voice recognition apparatus in FIG. 2 is different from the conventional voice recognition apparatus in FIG. 1 in that text data 11 representing the contents of an uttered voice and voice data 12 obtained by allowing a user to utter the contents of the text data are input from a voice information input part 13. More specifically, the user inputs the text data 11 describing the contents of an uttered voice and the uttered voice data 12 as a pair of data.

Thus, the text data 11 and the voice data 12 to be input must be stored as a pair of data. More specifically, as shown in FIG. 2, a pair of the text data 11 and the voice data 12 are stored in a voice information storing part 21. Therefore, even in the case of using a plurality of voice recognition apparatuses, a pair of the text data 11 and the voice data 12 that have already been stored only need to be input in each voice recognition apparatus. Even in the case where the user newly uses a voice recognition apparatus, the user is not required to newly input voice data, merely by inputting a pair of the text data 11 and voice data 12 that have been stored.

Furthermore, the voice information storing part 21 may be placed in the voice recognition apparatus as shown in FIG. 2, or may be placed as an accessible data server on a network environment. Because of this, even if a user uses any voice recognition apparatus, the user is expected to obtain the recognition precision to the same degree, as long as the apparatus is connected via a network.

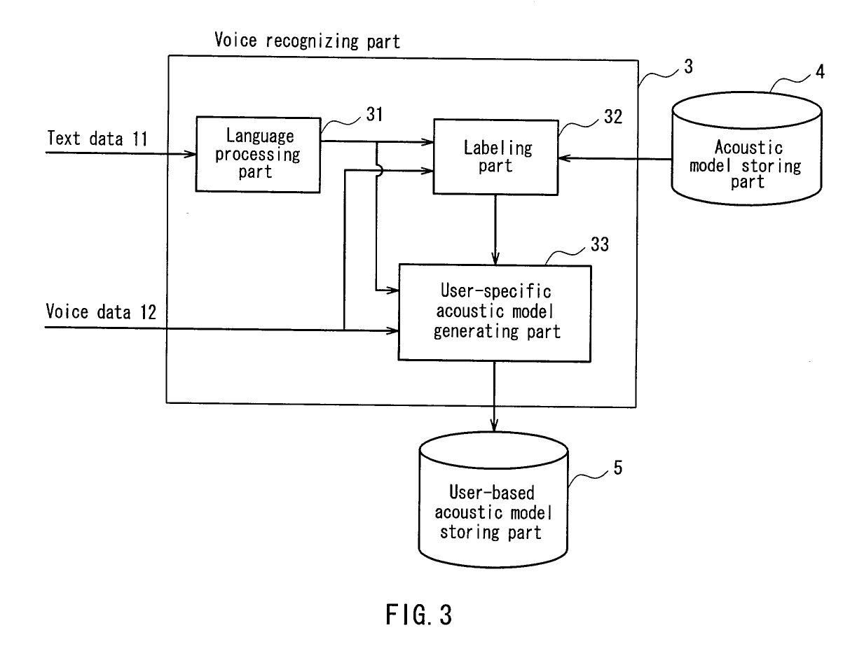

FIG. 3 shows a detailed configuration of a voice recognizing part 3 in the voice recognition apparatus of Embodiment 1 according to the present invention. In FIG. 3, reference numeral 31 denotes a language processing part, 32 denotes a labeling part, and 33 denotes a user-specific acoustic model generating part.

First, in the language processing part 31, a phoneme line is generated with respect to the text data 11 among the inputs in the voice information input part 13. More specifically, in the language processing part 31, a phoneme line is generated with reference to an acoustic model generated based on voice data regarding an infinite number of users previously stored in the acoustic model storing part 4, in accordance with the definition of phonemes used by the acoustic model.

In the labeling part 32, labeling of the voice data 12 is conducted based on the acoustic model in the acoustic model storing part 4 in accordance with the phoneme line generated in the language processing part 31. Due to this labeling, the voice data and the text data are associated with each other.

In Embodiment 1, a general HMM is also adopted as an acoustic model in the same way as in the conventional example. Furthermore, it is assumed that labeling is conducted by obtaining an optimum phoneme group, using a Viterbi algorithm with respect to the HMM. Needless to say, the configuration of an acoustic model is not particularly limited to a HMM. There is no particular limit to a labeling method.

In the user-specific acoustic model generating part 33, a user-specific acoustic model is generated based on the voice data 12 and the labeling results. The configuration of the user-specific acoustic model is the same as that of the acoustic model previously stored in the acoustic model storing part 4.

The following may also be possible: based on the acoustic model stored in the acoustic model storing part 4, voice data corresponding to a phoneme line in which the labeling results are different from the contents of an actually uttered voice is excluded, and the voice data itself is updated or the like, whereby a user-specific acoustic model is generated as an additional or corrected model.

Some phoneme lines generated in the language processing part 31 may lack accuracy depending upon the processing method. Similarly, the acoustic model generated based on voice data regarding an unspecified user may not always be a model with a high recognition precision, depending upon the contents of a voice uttered by a user. Thus, the following may also be possible: a mismatching degree between the labeling results and the contents of an actually uttered voice is evaluated, and it is determined whether or not the input voice data can be used for generating a user-specific acoustic model.

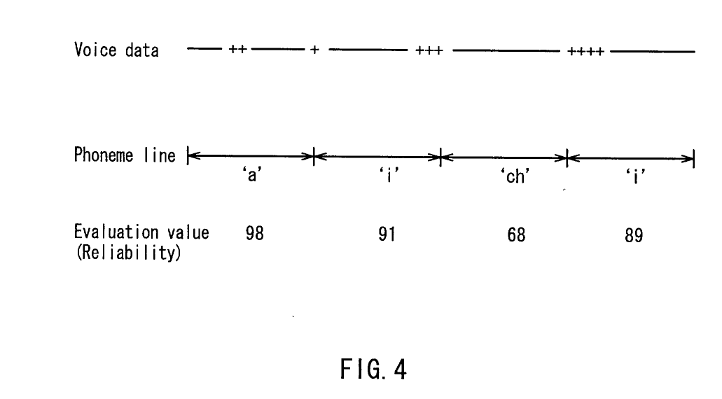

For example, as shown in FIG. 4, when voice data of a user regarding the contents of an uttered voice “a-i-ch-i” is input, the voice data is subjected to labeling, whereby the voice data can be decomposed to a phoneme line, and an evaluation value representing the reliability of the phoneme line can be calculated.

In FIG. 4, assuming that a standard for determining whether or not the voice data is used is an evaluation value “80”, the voice data in an interval of the phoneme line “ch” has low reliability, so that it is determined that the voice data cannot be used. Thus, only voice data corresponding to phonemes “a”, “i”, and “i” are used for generating or updating a user-specific acoustic model.

A method for previously learning the recognition results peculiar to a user is not limited to the above-mentioned method. For example, it may also be considered that a linear conversion function that associates a feature value group of typical phonemes based on voice data of an unspecified user with a feature value group of voice data of labeled phonemes is obtained and used as a filter 6.

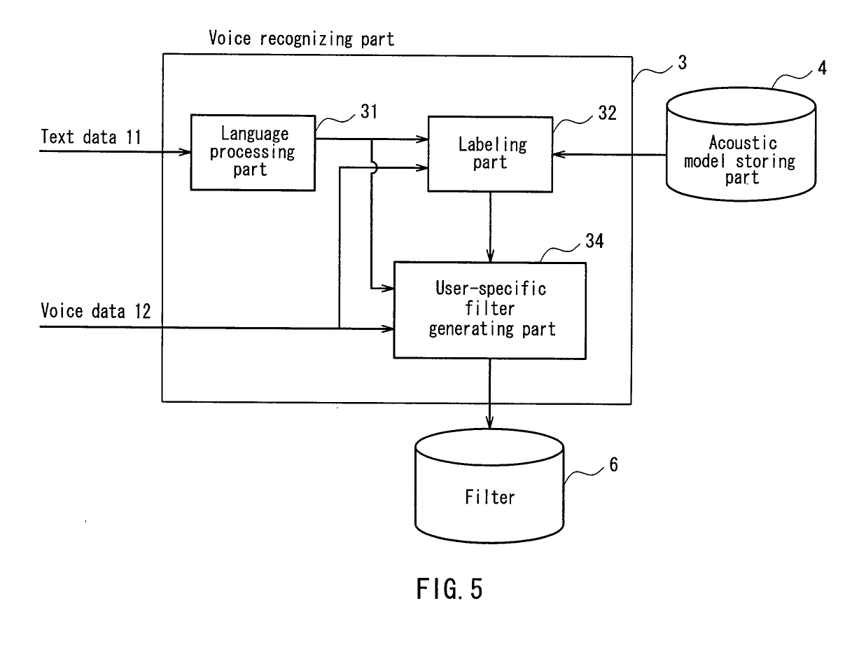

In the case of using the filter 6, as shown in FIG. 5, a user-specific filter generating part 34 is provided in the voice recognizing part 3, in place of the user-specific acoustic model generating part 33. In the user-specific filter generating part 34, a feature value group of typical phonemes that can be extracted from the acoustic model based on the voice data of an unspecified user is associated with labeling results, whereby a linear conversion function is stored as the filter 6.

Furthermore, in voice recognition, a feature value X of phonemes is obtained based on the input voice data, and a new acoustic feature value X′ is generated via the filter 6. Then, voice recognition is conducted by using the acoustic model stored in the acoustic model storing part 4 and the obtained acoustic feature value X′, whereby the same effects can be expected without generating a user-specific acoustic model.

Thus, it is not required to generate a user-specific acoustic model, and the filter 6 only needs to be stored. Therefore, a storage capacity may be small, and a computer resource can be used effectively.

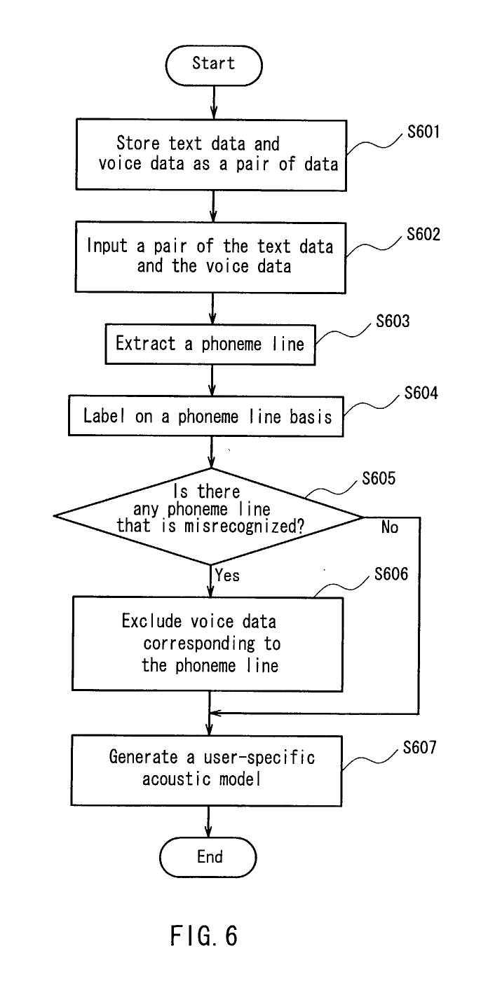

Hereinafter, a processing flow of a program for realizing the voice recognition apparatus of Embodiment 1 according to the present invention will be described. FIG. 6 shows a flow chart illustrating the processing of a program for realizing the voice recognition apparatus of Embodiment 1 according to the present invention.

As shown in FIG. 6, first, text data and voice data corresponding thereto are stored as a pair of data (Operation 601), and a pair of the stored text data and voice data are input (Operation 602).

Then, a phoneme line is extracted based on the input text data (Operation 603). Labeling with respect to the acoustic model generated based on the voice data of an unspecified user is conducted on the phoneme line basis (Operation 604). As a result of the labeling, it is determined whether or not there is a phoneme line matched with user's intention, i.e., whether of not there is a phoneme line that is misrecognized (Operation 605).

If there is a phoneme line that is misrecognized (Operation 605: Yes), voice data corresponding to the phoneme line is not used for generating a user-specific acoustic model (Operation 606). If there is no phoneme line that is misrecognized (Operation 605: No), all the contained voice data are used for generating a user-specific acoustic model to generate a user-specific acoustic model (Operation 607).

In Embodiment 1, although voice data that is misrecognized is excluded, only such voice data may be actively learned as data in which a difference with respect to the acoustic model of an unspecified speaker is conspicuous.

As described above, in Embodiment 1, even in the case where a plurality of voice recognition apparatuses are used, it is not required for a user to reinput a voice in respective voice recognition apparatuses, and it becomes possible to obtain a voice recognition apparatus in which a recognition precision at a predetermined level is maintained without allowing a user to conduct a repeated voice input operation.

Embodiment 2

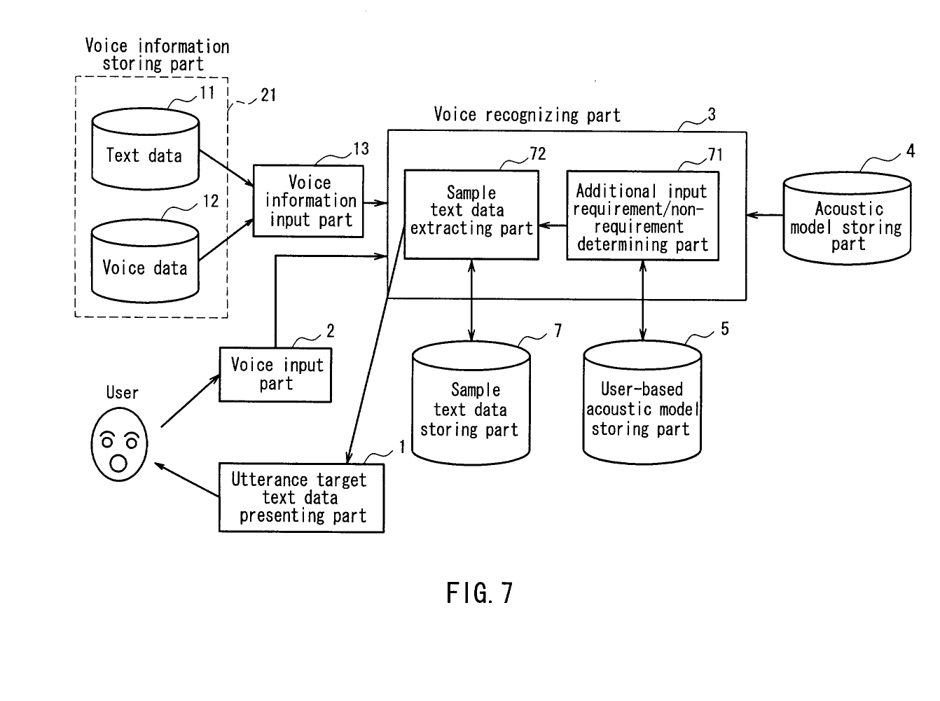

Hereinafter, a voice recognition apparatus of Embodiment 2 according to the present invention will be described with reference to the drawings. FIG. 7 is a view showing a configuration of the voice recognition apparatus of Embodiment 2 according to the present invention. In FIG. 7, parts having the same functions as those in FIGS. 1 and 2 are denoted with the same reference numerals as those therein, and detailed descriptions thereof will be omitted here.

In FIG. 7, the voice recognizing part 3 further includes an additional input requirement/non-requirement determining part 71 and a sample text data extracting part 72 for extracting required text data from sample text data stored in the sample text data storing part 7.

More specifically, when an enrollment is conducted and a user-specific acoustic model is generated in the voice recognition apparatus 3, the additional input requirement/non-requirement determining part 71 in the voice recognition apparatus 3 evaluates the user-specific acoustic model again, and determines whether or not the recognition precision sufficient as the acoustic model is ensured.

That is, it is determined whether or not voice data to be labeled as a particular phoneme line is missing in the user-specific acoustic model. In the example shown in FIG. 4, voice data is present regarding phonemes “a” and “i”, whereas regarding “ch”, corresponding voice data is not used for generating a user-specific acoustic model. Therefore, it can be confirmed that voice data to be labeled as a phoneme “ch” is missing. In order to enhance a recognition precision, voice data to be labeled as a phoneme “ch” only needs to be input again.

In the case where it is determined that a recognition precision sufficient as an acoustic model is not ensured, i.e., voice data corresponding to a particular phoneme line is missing, a phoneme or a phoneme line that is determined not to be contained in enrollment is extracted in the sample text data extracting part 72, and the corresponding phoneme or phoneme line is searched for from the sample text data stored in the sample text data storing part 7, and extracted as utterance target text data.

When sample text data containing a phoneme or phoneme line to be required is extracted, a user is asked to input a voice in the utterance target text data presenting part 1, and the user inputs the corresponding voice data through a voice input medium such as a microphone.

Herein, various data are considered as the sample text data stored in the sample text data storing part 7; however, the kind thereof is not particularly limited. For example, document data owned by a user or a document which a user is familiar with and often uses may be used.

Particularly in this case, the text data presented as the contents of an uttered voice is expected to contain a number of phrases which the user often uses. Therefore, it is considered as effective means in terms of enhancement of a recognition precision that the text data presented as the contents of an uttered voice is used as the text data 11 to be first stored in the voice information storing part 21.

If additionally input voice data and sample text data thus read are added as the voice data 12 and the text data 11, a recognition precision is expected to be further enhanced.

Furthermore, as the text data describing the contents of an uttered voice, the results obtained by allowing the voice recognition apparatus to recognize uttered voice data may be used. In this case, even if the results are misrecognized, by correcting text data itself, the results can be used as the data describing the contents of an uttered voice. In this case, it is also possible to enroll the association between language information and reading (acoustic phoneme).

For example, the case of a user who pronounces the word “today” as [todai] is considered. In this case, generally, “tudie” is presented when a voice is recognized first, and then, “tudie” is corrected to “today”. Because of this, although “today” is associated with [todei] in labeling by an acoustic model before correction, it is possible to enroll so that “today” is associated with [todai] after the user-specific acoustic model is generated.

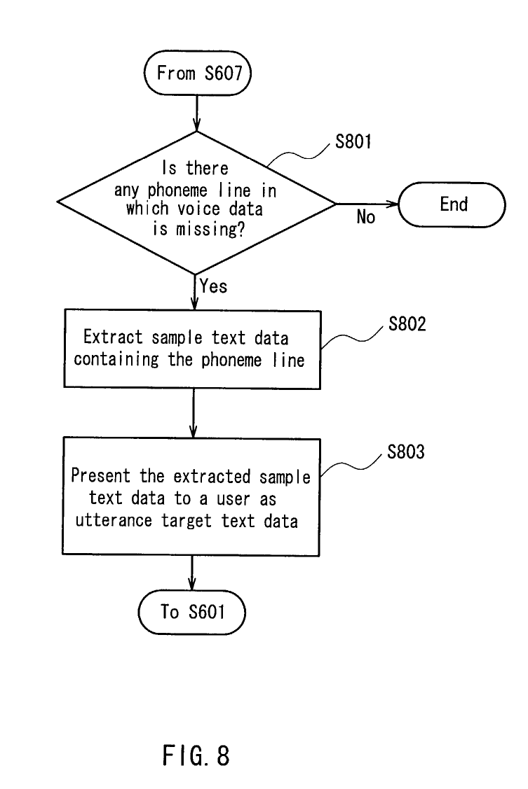

Hereinafter, a processing flow of a program for realizing the voice recognition apparatus of Embodiment 2 according to the present invention will be described. FIG. 8 is a partial flow chart illustrating the processing of a program for realizing the voice recognition apparatus of Embodiment 2 according to the present invention.

In FIG. 8, when a user-specific acoustic model is generated (Operation 607), the presence/absence of a phoneme line in which corresponding data is missing is searched for with respect to the acoustic model (Operation 801).

In the case where there is a phoneme line in which corresponding voice data is missing (Operation 801: Yes), sample text data containing the phoneme line is extracted from the sample text data storing part 7 (Operation 802), and the extracted sample text data is presented to a user as a new utterance target (Operation 803).

The user can generate a user-specific acoustic model with a higher recognition precision by newly storing and reinputting the voice data corresponding to the presented text data as a pair of data of the text data (Operations 601 and 602).

As described above, in Embodiment 2, even in the case where only an insufficient acoustic model is generated, necessary and sufficient voice data can be collected, and it is also possible to minimize a voice input by a user.

The voice recognition apparatus of the present invention is applicable to various applications utilizing a voice. As the most typical example, a voice word processor on a personal computer is considered. In the voice word processor, text data describing the contents of an uttered voice enrolled by a user and voice data can be accumulated every time the user uses the voice word processor. Therefore, the user can accumulate a large amount of data without feeling any burden of a data input, and enhancement of a voice recognition precision can be expected.

Enrollment data used for such a voice word processor generally has a large capacity. Therefore, it is difficult to apply such enrollment data to media having a physical limit to a storage capacity, such as a mobile phone.

In this case, enrollment data is limited so as to have one data with respect to at least one phoneme and held on a mobile phone side, whereby the voice recognition apparatus of the present invention can be used on media having a small storage capacity, such as a mobile phone.

For example, vowels “a, i, u, e, o” and voice data obtained by uttering these vowels are selected as an enrollment data set on a voice word processor, and only the enrollment data set is transferred to a mobile phone. When the word processor is used on the mobile phone, the enrollment data set is transmitted to a voice portal constituted by the voice recognition apparatus of the present invention, whereby it is not required for the user to input a voice for newly learning at the time of use.

Needless to say, in the case where a computer that drives a voice portal is always connected on the Internet, it is not necessary to hold the enrollment data set on the mobile phone side. For example, an automatic voice response system using a mobile phone will be exemplified. An address of a computer that is always connected on the Internet, holding enrollment data, is transmitted from a mobile phone to a server computer that provides an automatic voice response system, and the server computer that provides the automatic voice response system obtains enrollment data from the computer that is present at the address. Because of this, the recognition precision similar to that of the voice recognition apparatus in a generally used form can be expected without allowing the mobile phone side to hold an enrollment data set.

It is also considered that the voice recognition apparatus of the present invention is applied to a voice information search system utilizing VoIP (Voice over IP). For example, there is a system for obtaining information on a timetable and a transfer guidance, using the name of a station and the like as key information.

More specifically, based on voice data determining search conditions input in the search system, only an enrollment data set containing terms to be recognized among enrollment data sets accumulated in a computer that is driven by the voice recognition apparatus of the present invention is extracted, and transferred to a search server in the search system. Because of this, even in the case where only a small amount of enrollment data sets are present in the search server, it becomes possible to hold a high recognition precision.

For example, in the case where the enrollment data set includes “Osaka” and “Kobe” as the terms to be recognized, enrollment data containing voice data obtained by uttering these terms, for example, “I want to go to Osaka”, “I arrived at Kobe”, and the like are selected and transmitted to the search server.

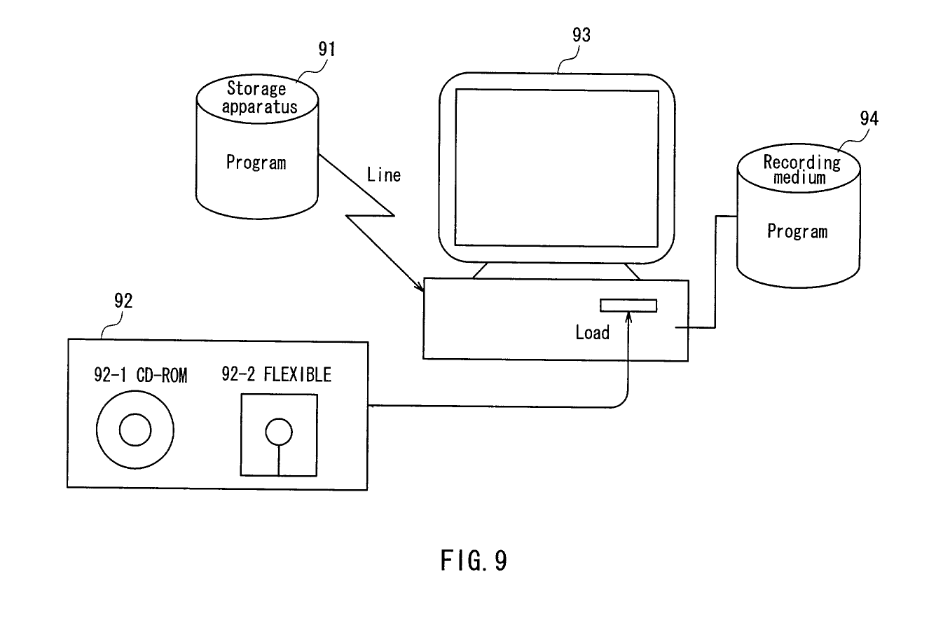

The program for realizing the voice recognition apparatus of the embodiments according to the present invention may be stored not only in a portable recording medium 92 such as a CD-ROM 92-1 and a flexible disk 92-2, but also in any of another storage apparatus 91 provided at the end of a communication line and a recording medium 94 such as a hard disk and a RAM of a computer 93, as shown in FIG. 9. In execution, the program is loaded and executed on a main memory.

Furthermore, a user-specific acoustic model and the like generated by the voice recognition apparatus of the embodiments according to the present invention may be stored not only in a portable recording medium 92 such as a CD-ROM 92-1 and a flexible disk 92-2, but also in any of another storage apparatus 91 provided at the end of a communication line and a recording medium 94 such as a hard disk and a RAM of a computer 93, as shown in FIG. 9. For example, the user-specific acoustic model and the like are read by the computer 93 when the voice recognition apparatus of the present invention is used.

As described above, according to the present invention, even in the case where a plurality of voice recognition apparatuses are used, it is not required for a user to reinput a voice for respective voice recognition apparatuses, and it becomes possible to obtain a voice recognition apparatus in which a recognition precision at a predetermined level is maintained without allowing a user to conduct a repeated voice input operation.

Furthermore, in the voice recognition apparatus of the present invention, the contents of an uttered voice of voice data for enrollment are not specified. Therefore, it becomes possible to enroll the contents of an uttered voice which a user likes.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A voice recognition apparatus, comprising:
a voice information storing part for storing, as a pair of data, text data describing contents of an uttered voice and voice data uttered by a user corresponding to the text data; and
a voice information input part for inputting the text data and the voice data,
wherein recognition results peculiar to the user are learned before start-up based on the text data and the voice data that are a pair of data.

2. A voice recognition apparatus according to claim 1, wherein the voice information storing part is a data server accessible via a network.

3. A voice recognition apparatus according to claim 1, wherein the text data is created based on a document owned by the user.

4. A voice recognition apparatus according to claim 1, wherein the recognition results or results obtained by correcting the recognition results are used as the text data.

5. A voice recognition apparatus according to claim 1, wherein the text data describing contents of an uttered voice and the voice data uttered by a user corresponding to the text data are stored as a pair of data in a physically movable storage medium.

6. A voice recognition apparatus according to claim 5, wherein a pair of the text data and the voice data stored in the physically movable storage medium are input from the voice information input part.

7. A method for recognizing a voice, comprising:
storing, as a pair of data, text data describing contents of an uttered voice and voice data uttered by a user corresponding to the text data; and
inputting the text data and the voice data,
wherein recognition results peculiar to the user are learned before start-up based on the text data and the voice data that are a pair of data.

8. A recording medium storing a program to be executed by a computer for realizing a method for recognizing a voice, the program comprising:
storing, as a pair of data, text data describing contents of an uttered voice and voice data uttered by a user corresponding to the text data; and
inputting the text data and the voice data,
wherein recognition results peculiar to the user are learned before start-up based on the text data and the voice data that are a pair of data.
